(19) United States
(12) Patent Application Publication
(10) Pub. No.: US 2009/0035729 A1
(43) Pub. Date: Feb. 5, 2009

(54) Apparatus for Chewing Obstruction

(76) Inventor: Meir Pele, Modein (IL)

Correspondence Address: HAIM FACTOR;Ofek Group Inc., 16192 Coastal Highway, Lewes, DE, 19958, US

(21) Appl. No.: 11/832,701

(22) Filed: Aug. 2, 2007

(51) Int. Cl. A61C 13/00

(52) U.S. Cl. 433/229

(57) ABSTRACT

In one aspect, the present invention is directed to an apparatus for chewing obstruction, the apparatus comprising: a pad, the contour of which corresponds to the contour of one or more molar or premolar teeth; and an adherent, for adhering the pad to one or more molar teeth. Preferably, the thickness of the pad is substantially between 0.5 to 10 mm. The adherent may comprise an adhesive substance. The pad may comprise a flexible substance, such as a spongy material (e.g., polypropylene) and rubber. According to one embodiment of the invention, the adherent is adapted to lose the adhesiveness thereof after a certain time period. Preferably, the time period is between one and five hours. In another aspect, the present invention is directed to a medicament form, comprising: a pad in which a dissolving medicament is absorbed; and an adherent, for adhering said pad to one or more teeth.

### FIELD OF THE INVENTION

The present invention relates to the field of healthcare. More particularly, the invention relates to an apparatus for obstructing chewing.

### BACKGROUND OF THE INVENTION

The term “overweight” is generally used to indicate a human with more body fat than is considered normative and/or useful for optimal functioning of the body. Obesity (seriously overweight, generally a term representing those 20 or more kilos overweight) is a critical problem in the lives of many people in the more developed parts of the world. Being overweight is a fairly common condition for many, especially those in developed nations where food supplies are plentiful and lifestyles often do not involve sufficient activities to generate caloric expenditure. Recent studies have indicated that as much as 64% of the adult US population is overweight, and this number is steadily increasing. (Katherine M. Flegal, PhD; Margaret D. Carroll, M S; Cynthia L. Ogden, PhD; Clifford L. Johnson, MSPH (2002). “Prevalence and Trends in Obesity Among US Adults, 1999-2000”. JAMA 288 (14): 1723-1727. PMID 12365955). A series of graphics from the CDC also describes the obesity prevalence trends in the U.S. in the past 2 decades: Obesity Epidemic: U.S. Temporal Trends 1985-2004.

Many people are interested in losing weight and face serious challenges in trying to start, effect and continue weight-reduction diets. Diet tips and plans are not enough in effecting the change of lifelong habits of consuming too much of the wrong foods.

There exist both profit-oriented and non-profit weight loss organizations which assist people in their weight loss efforts. Examples of the former include Weight Watchers and Jenny Craig; examples of the latter include Overeaters Anonymous, as well as a multitude of non-branded support groups run by local churches, hospitals, and like-minded individuals.

Weight-loss diets restrict the intake of specific foods, or food in general, to reduce body weight. What works for one individual will not necessarily work for another, due to metabolic differences and lifestyle factors. Also, for a variety of reasons, most people find it very difficult to maintain significant weight loss over time. There is some research suggesting rapid weight loss may actually make it more difficult to maintain the loss over time. It is also possible that cutting calorie intake too drastically slows or even prevents weight loss. The National Institute of Health notes that the commonly recommended program of reduced caloric intake along with increased physical activity has a failure rate of 98%.

In the more extreme cases, people suffering from overweight conditions can ultimately become obese. Obesity is a condition in which the natural energy reserve, stored in the fatty tissue of humans, increases to the point at which it threatens health and increases mortality. Obesity is both an individual clinical condition and increasingly viewed as a widespread, serious public health problem. Excessive body weight has been shown to predispose individuals to various diseases, particularly cardiovascular diseases, diabetes mellitus type 2, sleep apnea, and osteoarthritis. (U.S. Dept. of Health and Human Services, National Institutes of Health, ‘The Practical Guide: Identification, Evaluation and Treatment of Overweight and Obesity in Adults 5.’ [2000]). Obesity has come to be seen more as a medical condition in modern Western culture, even being referred to as an epidemic. (Phillips, Stone. “Who's to blame for the U.S. obesity epidemic?”. MSNBC, 2006-08-18. Retrieved on 2007-06-03).

It is an object of the present invention to provide an apparatus for diet control as a means for losing weight.

It is another object of the present invention to provide an apparatus for regulating healthy eating habits.

Other objects and advantages of the invention will become apparent as the description proceeds.

### SUMMARY OF THE INVENTION

The following embodiments and aspects thereof are described and illustrated in conjunction with systems, tools and methods, which are meant to be merely illustrative, not limiting in scope. In various embodiments, one or more of the above-described problems have been reduced or eliminated, while other embodiments are directed to other advantages or improvements.

In one aspect, the present invention is directed to an apparatus for obstructing chewing, the apparatus comprising:
a pad the contour of which corresponds to the contour of one or more molar or premolar teeth; and
an adherent, for adhering the pad to one or more molar or premolar teeth.

Preferably, the thickness of the pad is substantially between 0.5 to 10 mm.

The adherent may comprise adhesive substance. The adherent may be placed on one side of the pad.

The pad may comprise a flexible substance, such as a spongy material (e.g., polypropylene) and rubber.

According to one embodiment of the invention, the adherent is adapted to lose adhesiveness thereof after a certain time period. Preferably, the time period is between one and five hours.

The surface of the pad may correspond to the surface of one or more molar or premolar teeth, especially adjacent teeth.

Preferably, the adherent and the pad are made of non-toxic substances.

The adherent may comprise an ethanol-based substance, acetone-based substance, and so forth.

The pad may comprise a dissolving substance. In one embodiment of the invention, the dissolving substance is a medicament.

The characteristics of the pad may be adapted to intense chewing obstruction, such as by increasing the thickness and the adhesiveness of the pad.

In another aspect, the present invention is directed to a medicament form, comprising:
a pad in which a dissolving medicament is absorbed; and
an adherent, for adhering said pad to one or more teeth.

In addition to the exemplary aspects and embodiments described above, further aspects and embodiments will become apparent by reference to the figures and by study of the following detailed description.

### BRIEF DESCRIPTION OF THE DRAWINGS

The objects and features of the present invention will become apparent from the following detailed description considered in conjunction with the accompanying drawings, in which:

FIG. 1 pictorially illustrates an apparatus for chewing obstruction, according to one embodiment of the invention.

FIG. 2 schematically illustrates the lower dental arch of an individual in which a plurality of apparatuses for chewing obstruction are adhered to molar teeth 6b thereof, according to one embodiment of the invention.

FIG. 3 schematically illustrates the upper dental arch of an individual in which plurality of apparatuses for chewing obstruction are adhered to the upper molar teeth thereof, according to one embodiment of the invention.

FIG. 4 is a bottom view of the upper dental arch of an individual to which plurality of apparatuses for chewing obstruction are adhered, according to one embodiment of the invention.

FIG. 5 is a top view of the lower dental arch of an individual to which plurality of apparatuses for chewing obstruction are adhered, according to one embodiment of the invention.

FIG. 6 schematically illustrates a packing means for a plurality of apparatuses for chewing obstruction, according to one embodiment of the invention.

It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein. Reference numerals may be repeated among the figures in order to indicate corresponding or analogous elements.

### DETAILED DESCRIPTION OF PREFERRED EMBODIMENTS

In the following detailed description, numerous specific details are set forth in order to provide a thorough understanding of the invention. However, it will be understood by those skilled in the art that the present invention may be practiced without these specific details. In some instances, well-known methods, procedures, components and circuits have not been described in detail, for the sake of clarity.

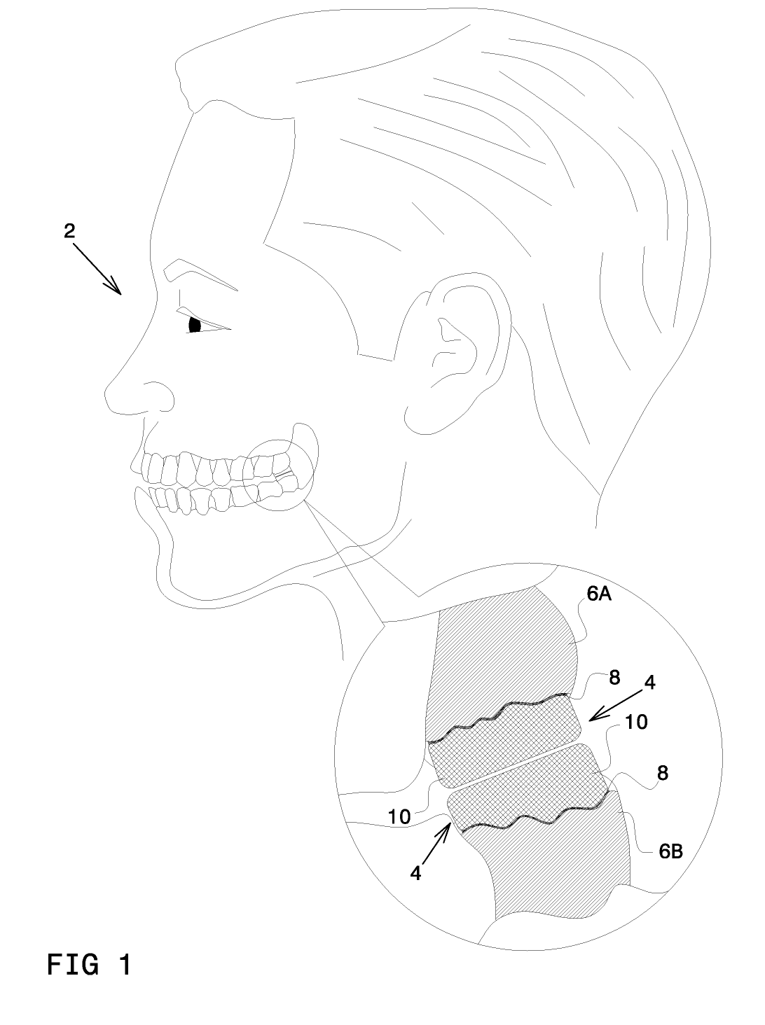

FIG. 1 pictorially illustrates two apparatuses for chewing obstruction 4, according to one embodiment of the invention.

According to this embodiment of the invention, each of the apparatus for chewing obstruction 4 comprises at least one pad 10, placed between an upper rear tooth 6a and a lower rear tooth 6b of an individual. Numeral 6a denotes an upper molar tooth, while numeral 6b denotes a lower molar tooth.

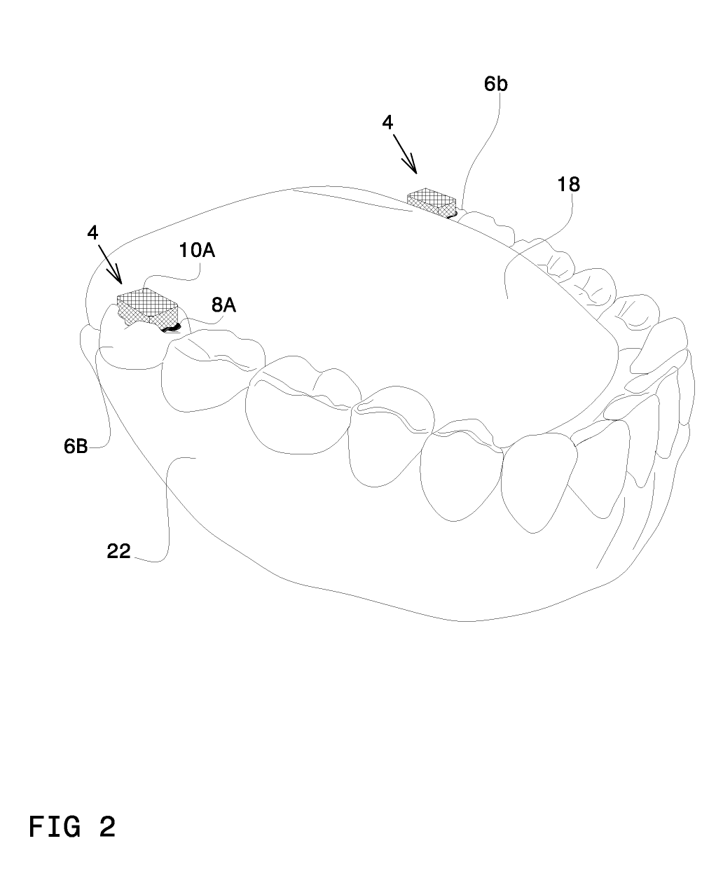

FIG. 2 schematically illustrates the lower dental arch of an individual in which an apparatuses for obstructing chewing 4 is adhered to its molar teeth 6b, according to one embodiment of the invention.

In this illustration numeral 18 denotes a tongue, and numeral 22 denotes a jaw.

The apparatus for chewing obstruction may be adhered to a molar tooth, to a premolar tooth, to a plurality of adjacent teeth, and so on.

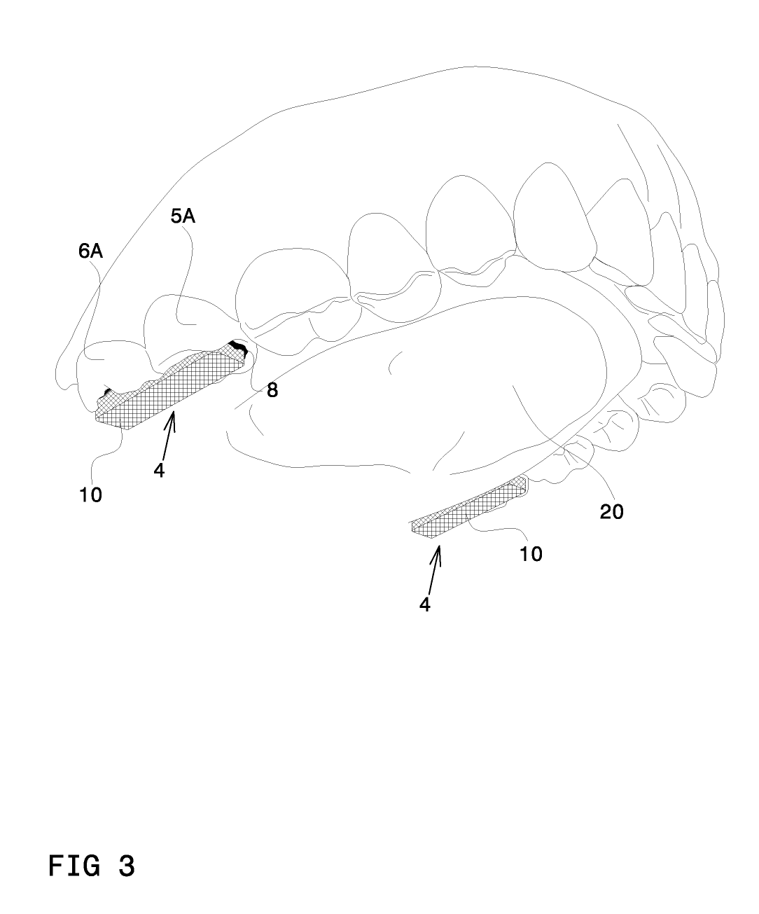

FIG. 3 schematically illustrates the upper dental arch of an individual in which an apparatus for obstructing chewing 4 is adhered to the two adjacent molar teeth 5a and 6a, according to one embodiment of the invention.

In this illustration, each of pads 10 corresponds to two adjacent molar teeth, in contrast to the embodiment of FIG. 2, in which a pad corresponds to a single molar tooth.

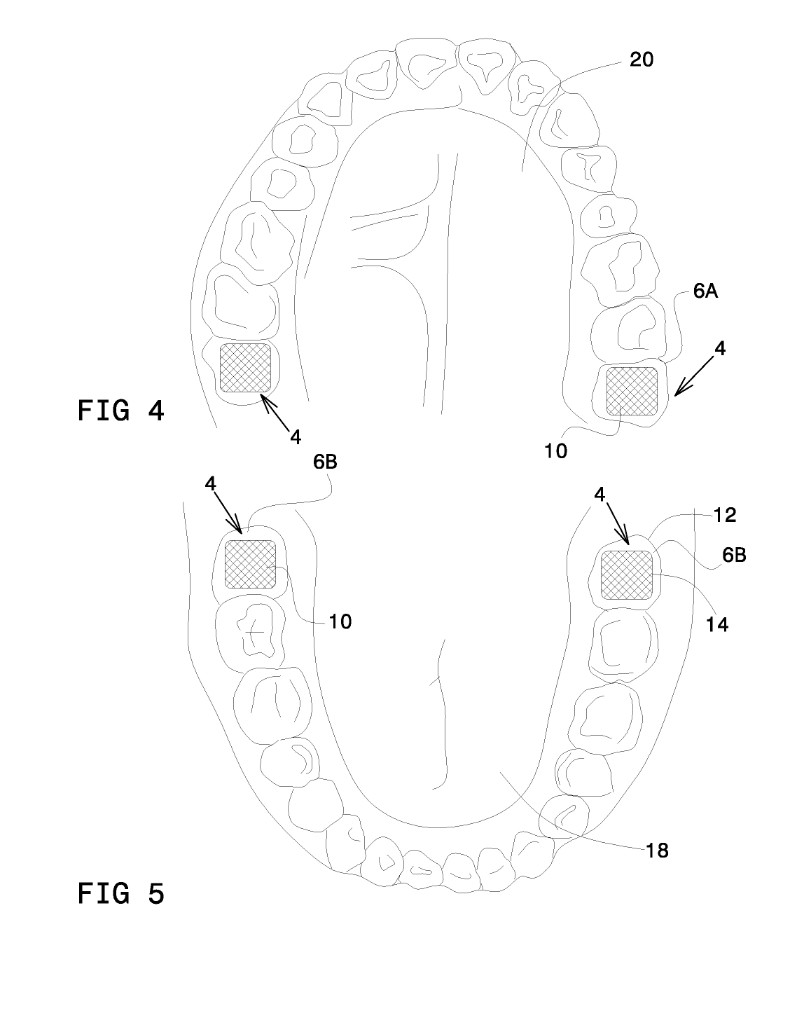

FIG. 4 is a bottom view of the upper dental arch of an individual to which plurality of apparatuses for chewing obstruction 4 are adhered, according to one embodiment of the invention.

FIG. 5 is a top view of the lower dental arch of an individual to which plurality of apparatuses for chewing obstruction 4 are adhered, according to one embodiment of the invention.

### Structure

According to embodiments of the present invention, the contour of a dental pad of an apparatus for chewing obstruction corresponds to the contour of the molar tooth/teeth thereof. This is better viewed in FIGS. 4 and 5.

For example, in FIG. 5, numeral 12 denotes the contour of the molar tooth 6b, while numeral 14 denotes the contour of pad 10 of the apparatus for chewing obstruction 4. In this case, contour 14 of the apparatus “corresponds” to contour 12 of the tooth thereof, i.e., when placing an apparatus for chewing obstruction on a tooth, the contour of the apparatus and the contour of the tooth are about the same scale. As can be seen, although contour 14 is square and contour 12 is not, their scale remains about the same. In this case, contour 14 of pad 10 does not exceed the limits of contour 12 of the tooth thereof.

Of course, the dimensions of the pad need not be uniform in all embodiments. The dimensions of the pad may be varied, for example, to correspond with the age of the individual. For example, one scale may be referred to as “mini” and another as “large”.

According to embodiments of the present invention, the thickness of a dental pad is between approximately 0.5 mm to 10 mm, and preferably between 1 to 3 mm.

According to one embodiment of the invention, a pad of an apparatus for chewing obstruction is of spongy material, such as polypropylene, which shrinks upon pressure. As such, according to this embodiment of the invention the form of the pad is self adjustable according to a tooth's surface.

According to one embodiment of the invention, the surface of one side of a dental pad comprises an adhesive layer 8, for adhering a pad 10 to a tooth.

The apparatus may be packed in an oilcloth, may comprise an oilcloth cover attached to the adhesive layer thereof, and so on.

### Use

The presence of a foreign object between the teeth of the upper and lower dental arches of an individual causes a psychological interference to the ordinary sensation of eating. As a result, the presence of a strange object interferes in the individual's normal eating habits. This fact is used by the present invention to inhibit undesired eating habits. For example, an individual that uses an apparatus for obstructing chewing between 08:00 AM and 12:00 noon for a certain period (e.g., a week) becomes accustomed to not eating between these hours.

Furthermore, eating is a source of pleasure. However, placement of a foreign object between the upper and lower dental arches of an individual, especially between the molar teeth thereof, is a detriment to pleasure, and as such the appetite of the individual may be decreased.

The presence of a foreign object between the upper and lower arches of an individual also affects the individual's ability to chew. Thus, beyond the psychological block, presence of such an object is also a certain physical obstacle.

A user may use more than one apparatus at one time for obstructing chewing.

The longevity of adherence to the tooth of the apparatus for chewing obstruction may depend, for example, on the adhesive substance, the concentration thereof, and so forth. Thus, the duration a dental pad retains adhered to a tooth may be adjusted by changing the adherent parameters, such as the composition of the adherent, the concentration of the adhesive substance in the composition, and so forth.

For example, in order to become accustomed to abstaining from eating between meals, as recommended by dieticians, the adhesive of an adherent should be effective about three to four hours.

Although the individual may not be able to eat while the apparatus for chewing obstruction is in position in his mouth, he may freely drink liquids.

According to one embodiment of the invention, a pad of an apparatus for chewing obstruction comprises a medicament which dissolves as time passes. Thus, according to this embodiment of the invention, the apparatus for chewing obstruction may be used as a medicament form, much like injections and pills.

The benefit of a medication provided this way in comparison to other forms of medications, such as pills, injections and skin patches, is that the pad dissolves “slowly” and within the individual's mouth. The dissolving may be a result of a reaction between the pad's substance with a user's saliva, and so on.

### Packing

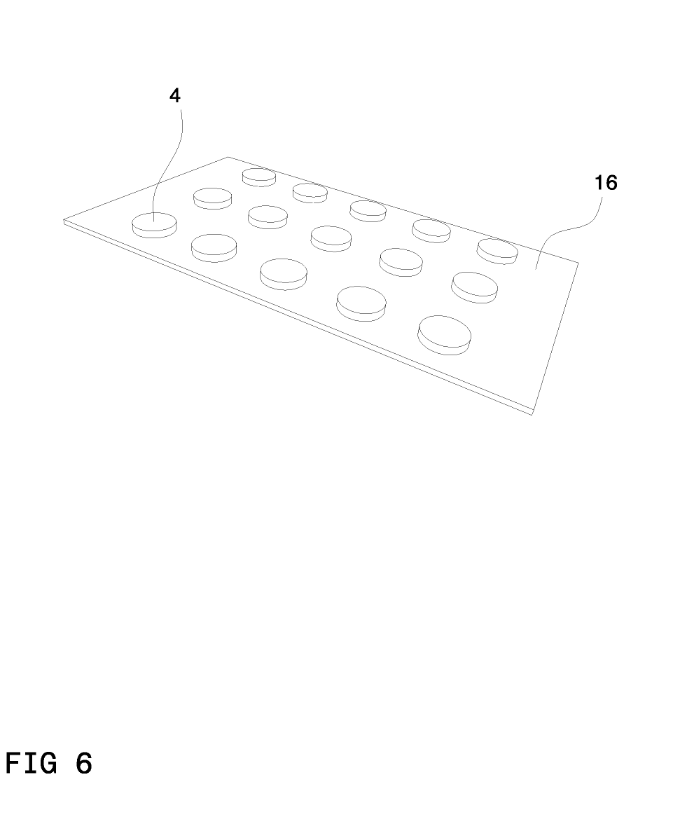

FIG. 6 schematically illustrates a packing means for a plurality of apparatuses for chewing obstruction, according to one embodiment of the invention.

The packing means is actually a packing which may comprise one or more oilcloth sheets 16, on which a plurality of apparatuses for chewing obstruction 4 is adhered. Upon removing an apparatus 4 from the oilcloth, the adhesive layer used for adhering apparatus 4 to sheet 16 may be used for adhering the apparatus to a tooth. The packing is preferably hermetically sealed.

According to another embodiment of the invention, an oilcloth cover is attached to the adherent of a pad. Thus, in order to use the pad, a user must remove the oilcloth cover.

### Substances

According to one embodiment of the invention, the substance of the pad is of spongy material, such as polypropylene, which shrinks upon pressure. As such, according to this embodiment of the invention, an apparatus for chewing obstruction is adjustable according to a tooth upper/lower surface correspondingly.

The substance of a pad and the adhesive thereof must be non-toxic.

Presently, non-toxic adherents are commonly in use for dental care, especially for temporary fillings, such as self-etching bonding agents (e.g., self-etching primers or dental adhesives such as acetone-based adhesive systems or ethanol-based systems). A relatively low concentration of self-etching primers (in comparison to the concentration of temporary dental fillings) may be used as adhesive substance for dental pads.

For example, the 3M™ ESPE™ Adper™ Scotchbond™ Multi-Purpose Plus Dental Adhesive is distributed under several trademarks, such as Scotchbond®.

While certain features of the invention have been illustrated and described herein, the invention can be embodied in other forms, ways, modifications, substitutions, changes, equivalents, and so forth. The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. An apparatus for chewing obstruction, the apparatus comprising:
a pad the contour of which corresponds to the contour of one or more adjacent molar or premolar teeth; and
an adherent, for adhering said pad to one or more molar or premolar teeth.

2. An apparatus according to claim 1, wherein the thickness of said pad is substantially between 0.5 to 10 mm.

3. An apparatus according to claim 1, wherein said adherent comprises an adhesive substance.

4. An apparatus according to claim 1, wherein said adherent is placed on one side of said pad.

5. An apparatus according to claim 1, wherein said pad comprises a flexible substance.

6. An apparatus according to claim 5, wherein said flexible substance comprises a spongy material.

7. An apparatus according to claim 5, wherein said flexible substance comprises polypropylene.

8. An apparatus according to claim 5, wherein said flexible substance comprises rubber.

9. An apparatus according to claim 1, wherein said adherent is adapted to lose the adhesiveness thereof after a certain time period.

10. An apparatus according to claim 9, wherein said time period is between two to five hours.

11. An apparatus according to claim 1, wherein said pad comprises a dissolving substance.

12. An apparatus according to claim 11, wherein said dissolving substance is a medicament.

13. An apparatus according to claim 1, wherein the surface of said pad corresponds to the surface of said one or more molar or premolar teeth.

14. An apparatus according to claim 1, wherein said adherent and said pad are comprised of non-toxic substances.

15. An apparatus according to claim 1, wherein said adherent comprises a substance based on a member of a group comprising: ethanol and acetone.

16. An apparatus according to claim 1, further comprising a cover.

17. An apparatus according to claim 16, wherein said cover is an oilcloth sheet adhered to said adherent.

18. An apparatus according to claim 1, wherein the characteristics of said pad are adapted to obstruct chewing.

19. An apparatus according to claim 18, wherein said characteristics are selected from a group comprising: thickness and adhesiveness.

20. A medicament form, comprising:
a pad in which a dissolving medicament is absorbed; and
an adherent, for adhering said pad to one or more teeth.
